(19) United States
(12) Patent Application Publication
(10) Pub. No.: US 2010/0259940 A1
(43) Pub. Date: Oct. 14, 2010

(54) COVER FOR A DISPLAY SCREEN AND ELECTRONIC DEVICE BY HAVING SAME

(75) Inventors: CHWAN-HWA CHIANG, Shindian (TW); FENG-YUEN DAI, Shindian (TW)

Correspondence Address: Altis Law Group, Inc.;ATTN: Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/647,641

(22) Filed: Dec. 28, 2009

(30) Foreign Application Priority Data
Apr. 13, 2009 (CN) 200910301517.3

(51) Int. Cl. F21V 11/00; B32B 15/00; B32B 5/00; B32B 9/04; B32B 27/36; B32B 17/00

(52) U.S. Cl. 362/351; 428/457; 428/336; 428/446; 428/412; 428/426

(57) ABSTRACT

A cover for a display screen is described. The cover for a display screen comprises a transparent substrate, a light transmission enhancing coating formed on the substrate, and a metallic coating formed on the light transmission enhancing coating. An electronic device by having the cover for a display screen is also described.

### BACKGROUND

1. Technical Field

The present disclosure relates to a cover for a display screen, especially to a cover for a display screen having a mirror-like appearance and an electronic device by having the cover for a display screen.

2. Description of Related Art

A cover for a display screen having a metallic appearance is often considered more attractive. The common method of manufacturing the cover for a display screen having the metallic appearance is by applying a metal coating on the cover for a display screen using vacuum deposition. The metal coating should not block electromagnetic waves, and at the same time, the metal coating should have high light transmission property. However, metal coatings sometimes block too much light.

Therefore, there is room for improvement within the art.

### BRIEF DESCRIPTION OF THE FIGURES

Many aspects of the cover for a display screen and an electronic device having such a cover can be better understood with reference to the following figures. The components in the figures are not necessarily drawn to scale, the emphasis instead being placed upon clearly illustrating the principles of the cover for a display and the electronic device. Moreover, in the drawings like reference numerals designate corresponding parts throughout the several views.

FIG. 1 is a cross-sectional view of an exemplary embodiment of a cover for a display screen.

FIG. 2 is a schematic view of an exemplary embodiment of an electronic device having the cover for a display screen shown in FIG. 1.

### DETAILED DESCRIPTION

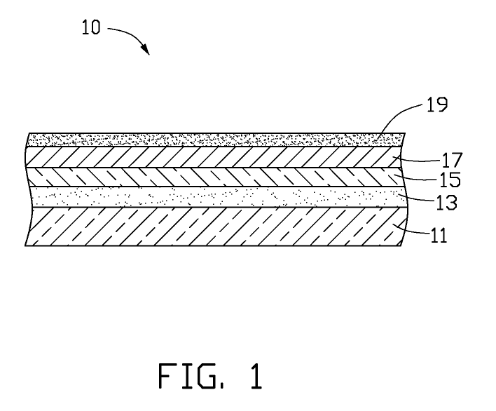

Referring to FIG. 1, in an exemplary embodiment, a cover for a display screen 10 includes a substrate 11, a base coating 13 formed on one surface of the substrate 11, a light transmission enhancing coating 15 formed on the base coating 13, a metallic coating 17 formed on the light transmission enhancing coating 15, and a top coating 19 formed on the metallic coating 17.

The substrate 11 may be made of transparent plastic selected from a group consisting of polypropylene (PP), polyamide (PA), polycarbonate (PC), polymethyl methacrylate (PMMA), and polyethylene terephthalate (PET). Alternatively, the substrate 11 may be made of glass.

The base coating 13 may be a transparent ultraviolet (UV) curable paint coating. The UV curable paint may be polyurethane acrylate paint. The base coating 13 may have a thickness of about 6-12 μm.

The light transmission enhancing coating 15 may be a silicon dioxide film or a titanium dioxide film applied, for example, by vacuum deposition. The light transmission enhancing coating 15 may have a thickness of about 50-100 nm.

The metallic coating 17 may be, for example, an indium coating, a tin coating, or an aluminum silicon coating formed by vacuum deposition. The metallic coating 17 may have a metallic appearance. The metallic coating 17 may have a thickness in a range of about 50-150 nm, which should provide the desired metallic appearance without blocking excessive radio signals. When the cover for a display screen 10 is fixed on an electronic device and the electronic device is not in use, no light is emitted from the electronic device. Therefore, the metallic coating 17 will be highly reflective and have a mirror-like appearance. When the electronic device is in use the coatings allow light to be transmitted therethrough.

The top coating 19 may be a transparent paint coating having a thickness of about 8-15 μm. The paint used for forming the top coating 19 may be UV curable paint, polyurethane paint, or unsaturated polyester paint. In this exemplary embodiment, UV curable paint is used for the top coating 19. The top coating 19 may have a high rigidity and can protect the metallic coating 17 from abrasion. The paint used for the top coating 19 can be tinted for aesthetic reasons as long as it remains transparent.

The base coating 13 is applied as the bonding agent between the light transmission coating 15 and the substrate 11 but may be omitted in applications that allows a bond to be formed by applying the light transmission enhancing coating 15 directly on the substrate 11.

The top coating 19 may be omitted in applications where abrasion of the cover for a display screen is not a concern.

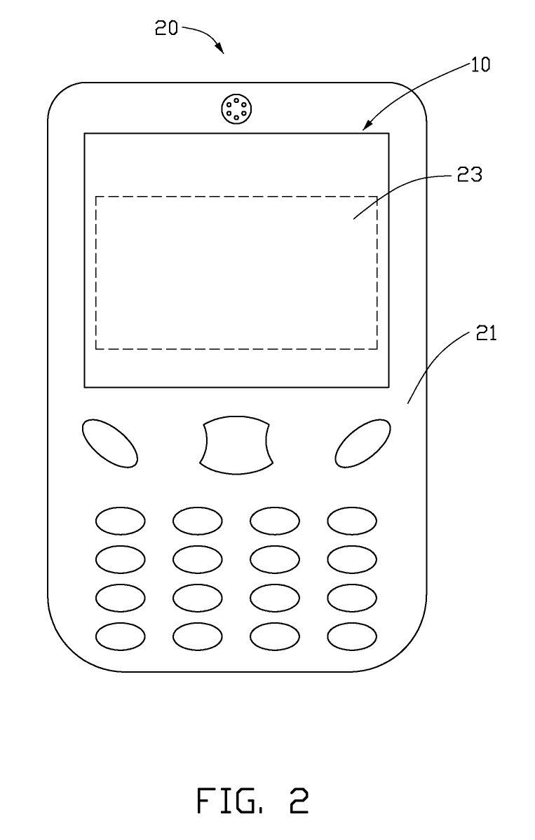

FIG. 2 shows an electronic device 20 including a main body 21 and a cover for a display screen 10. The main body 21 may have a display 23 and the cover for a display screen 10 is positioned over the display 23. The cover for a display screen 10 includes a substrate 11, a base coating 13 formed on one surface of the substrate 11, a light transmission enhancing coating 15 formed on the base coating 13, a metallic coating 17 formed on the light transmission enhancing coating 15, and a top coating 19 formed on the metallic coating 17. The substrate 11 faces the display 23 when the cover for a display screen 10 is positioned over the display 23. The display 23 of the main body 20 can emit light. The light emitted by the display 23 can transmit through the substrate 11, the base coating 13, and the light transmission enhancing coating 15, and with the enhancing effect of the light transmission enhancing coating 15, the light can further transmit through the metallic coating 17 and the top coating 19. When the electronic device 20 is not in use, the metallic coating 17 will be highly reflective and have a mirror-like appearance.

The exemplary electronic device 20 may be a mobile phone, a PDA, a MP3 or a MP4.

It should be understood, however, that though numerous characteristics and advantages of the present embodiments have been set forth in the foregoing description, together with details of functions of the embodiments, the disclosure is illustrative only, and changes may be made in detail within the principles of the disclosure to the full extent indicated by the broad general meaning of the terms in which the appended claims are expressed.

What is claimed is:

1. A cover for a display screen, comprising:
a transparent substrate;
a light transmission enhancing coating formed on the substrate; and
a metallic coating formed on the light transmission enhancing coating.

2. The cover for a display screen as claimed in claim 1, wherein the light transmission enhancing coating is a silicon dioxide film or a titanium dioxide film having a thickness of about 50-100 nm.

3. The cover for a display screen as claimed in claim 1, wherein the metallic coating is an indium coating, a tin coating, or an aluminum silicon coating formed by vacuum deposition.

4. The cover for a display screen as claimed in claim 3, wherein the metallic coating may have a thickness of about 50-150 nm.

5. The cover for a display screen as claimed in claim 1, wherein the cover for a display screen further includes a base coating formed between the substrate and the light transmission enhancing coating.

6. The cover for a display screen as claimed in claim 5, wherein the base coating is a transparent ultraviolet curable paint coating having a thickness of about 6-12 μm.

7. The cover for a display screen as claimed in claim 1, wherein the cover for a display screen further includes a top coating formed on the metallic coating, the top coating is a transparent ultraviolet curable paint coating having a thickness of about 8-15 μm.

8. The cover for a display screen as claimed in claim 1, wherein the substrate is made of transparent plastic selected from a group consisting of polypropylene, polyamide, polycarbonate, polymethyl methacrylate, and polyethylene terephthalate.

9. The cover for a display screen as claimed in claim 1, wherein the substrate is made of glass.

10. An electronic device, comprising:
a main body, the main body including a display; and
a cover for a display screen, the cover for a display screen being positioned over the display;
wherein the cover for a display screen includes a transparent substrate, a light transmission enhancing coating formed on the substrate, and a metallic coating formed on the light transmission enhancing coating; the display emit light, and the light transmits through the transparent substrate, the light transmission enhancing coating and the metallic coating.

11. The electronic device as claimed in claim 10, wherein the light transmission enhancing coating is a silicon dioxide film or a titanium dioxide film having a thickness of about 50-100 nm.

12. The electronic device as claimed in claim 10, wherein the metallic coating is an indium coating, a tin coating, or an aluminum silicon coating formed by vacuum deposition.

13. The electronic device as claimed in claim 12, wherein the metallic coating may have a thickness of about 50-150 nm.

14. The electronic device as claimed in claim 10, wherein the cover for a display screen further includes a base coating formed between the substrate and the light transmission enhancing coating.

15. The electronic device as claimed in claim 14, wherein the base coating is a transparent ultraviolet curable paint coating having a thickness of about 6-12 μm.

16. The electronic device as claimed in claim 10, wherein the cover for a display screen further includes a top coating formed on the metallic coating, the top coating is a transparent ultraviolet curable paint coating having a thickness of about 8-15 μm.

17. The electronic device as claimed in claim 10, wherein the substrate of the cover for a display screen is made of transparent plastic selected from a group consisting of polypropylene, polyamide, polycarbonate, polymethyl methacrylate, and polyethylene terephthalate.

18. The electronic device as claimed in claim 10, wherein the substrate of the cover for a display screen is made of glass.
